(19) United States
(12) Patent Application Publication
(10) Pub. No.: US 2009/0286457 A1
(43) Pub. Date: Nov. 19, 2009

(54) CUTTING WHEEL FOR POWER TOOLS

(76) Inventors: Beat Salzgeber, Visp (CH); Marzell Chanton, Niklaus (CH); Roberto Mulone, Niklaus (CH)

Correspondence Address: MICHAEL J. STRIKER, 103 EAST NECK ROAD, HUNTINGTON, NY, 11743, US

(21) Appl. No.: 12/446,916

(22) PCT Filed: Dec. 13, 2007
(86) PCT No.: PCT/EP2007/063904

§ 371 Date: Apr. 23, 2009

(30) Foreign Application Priority Data
Feb. 14, 2007 (DE) 102007006997.0

(51) Int. Cl. B24D 5/12; B28D 1/12; B23D 61/02

(52) U.S. Cl. 451/548; 125/15; 83/676

(57) ABSTRACT

A cut-off wheel for machine tools, in particular for handheld power grinders, has a blade body (8), on the outer edge of which at least two cutting segments (9) are mounted. Seen in the circumferential direction, the outer edge of the blade body is subdivided into identical segment receiving portions (10), each of which is assigned a cutting segment.

The invention relates to a cutting disk for power tools, in particular handheld power grinders such as angle grinders, as recited in the preamble to claim 1.

### PRIOR ART

DE 103 21 629 A1 has disclosed a cutting disk for an angle grinder that is composed of a circular disk body with a central opening for placing onto a drive spindle and individual cutting segments arranged along the outer edge of the disk body. The cutting segments, which are integrally joined to the outer edge of the disk body, e.g. by means of soldering or welding, are embodied identically to one another and are spaced apart from each other so that a gap is formed between each pair of adjacent cutting segments. The cutting segments are approximately rectangular in cross section and the side walls of adjacent cutting segments delimiting the gaps extend approximately parallel to each other.

The size and shape of the cutting segments are adapted to the diameter of the disk body. Disk bodies with different diameters require differently embodied cutting segments.

### DISCLOSURE OF THE INVENTION

Based on this prior art, the object of the invention is to use simple means to reduce the large variety of types in cutting disks with different-sized disk bodies and correspondingly associated cutting segments.

This object is attained according to the invention by means of the defining characteristics of claim 1. Suitable modifications are disclosed in the dependent claims.

According to the invention, the cutting disk for power tools has a disk body whose outer edge, viewed in the circumference direction, is divided into at least two identically embodied segment receiving sections that are each associated with a respective cutting segment. The segment receiving sections are embodied so that at least one subregion of such a segment receiving section is radially offset, in particular recessed from, an envelope curve that is situated around the outer edge of the disk body. This means that the segment receiving sections do not lie on a continuous circular path, but rather that the segment receiving sections are offset in relation to the circular path, resulting in an uneven path of the outer edge in the circumference direction. This opens up the possibility of embodying the segment receiving sections identically to one another, independently of the disk body diameter, so that identical cutting segments can also be used for disk bodies with different diameters. The use of identical cutting segments significantly reduces the large variety of parts.

In a suitable embodiment, all of the segment receiving sections that are distributed over the circumference in the various circular segments of the disk body are identically embodied so that it is also possible to use identical cutting segments for each disk body. It is additionally possible, however, to use two or more types of cutting segments on a disk body that are associated with either identical or different segment receiving sections on the outer edge of the disk body.

There are various conceivable embodiments of the segment receiving sections. On the one hand, there can be a rectilinear embodiment of a segment receiving section or a curved, in particular arc-shaped or partially arc-shaped embodiment; in the case of the arc-shaped embodiment, the radius differs from the radius of the disk body, i.e. is either larger or smaller than the disk body radius, but is preferably smaller than it. With rectilinear segment receiving sections, the disk body assumes the form of a polygon.

If segment receiving sections of various embodiments are provided on one disk body, then they can differ both in terms of their length and (additionally or alternatively, in terms of their geometry, i.e. can be embodied as curved or rectilinear. With a varying length of the segment receiving sections, the correspondingly associated cutting segments can also have a varying length. It is also possible, however, to use cutting segments of a constant length so that gaps of varying widths are produced between adjacent cutting segments. Gaps of this kind are preferably provided in any case, i.e. both with segment receiving sections of a constant length and with segment receiving sections of varying lengths.

At least one segment receiving section, but preferably all of the segment receiving sections of a disk body are embodied so that the center line through the two circumferential end points of the segment receiving section is perpendicular to a straight line that passes through the center point of the disk body and bisects the segment receiving section. The straight line is therefore the bisector of the segment receiving section, which bisector passes radially through the center of the cutting disk. With a perpendicular orientation of the center line of the segment receiving section to this straight line, the center line constitutes a tangent situated on or parallel to the circumference of the disk body. The center lines of immediately adjacent segment receiving sections enclose an angle in relation to each other. This embodiment can be used both with rectilinear segment receiving sections and curved segment receiving sections.

In an alternative embodiment, the angle between the center line of a segment receiving section and the above-mentioned straight line is not equal to 90° so that the center line does not extend parallel to a tangent on the circular envelope curve but rather, encloses an angle with this tangent. If a plurality of segment receiving sections of this kind are provided around the circumference of the disk body, then this yields a sawtooth-like path of the outer edge of the disk body.

The segmentation of the disk body with the segment receiving sections is essential; preferably, the number of differently formed segment receiving sections is kept to a minimum. It is then possible for the cutting segments to be placed onto the respectively associated segment receiving sections regardless of the diameter of the disk body and for them to be attached to the disk body, in particular integrally by means of soldering or welding.

For placement onto the outer edge of the disk body, the radial inside of the cutting segments is adapted to the respectively associated type of segment receiving section. The radial outside of the cutting segment, however, can be embodied independently of the segment receiving section; it is possible to have both a rectilinear embodiment of the radial outside and a curved, in particular arc-shaped, embodiment as well as undulating or zigzagging embodiments.

Other advantages and suitable embodiments can be inferred from the remaining claims, the description of the figures, and the drawings.

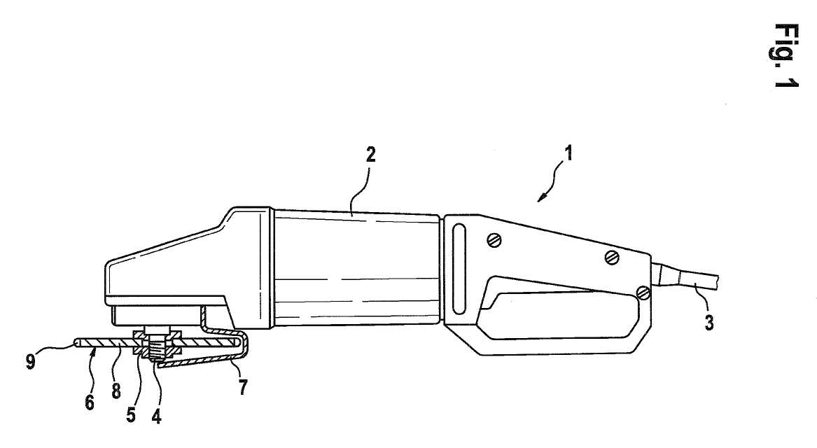

FIG. 1 shows an angle grinder with a cutting disk according to the invention,

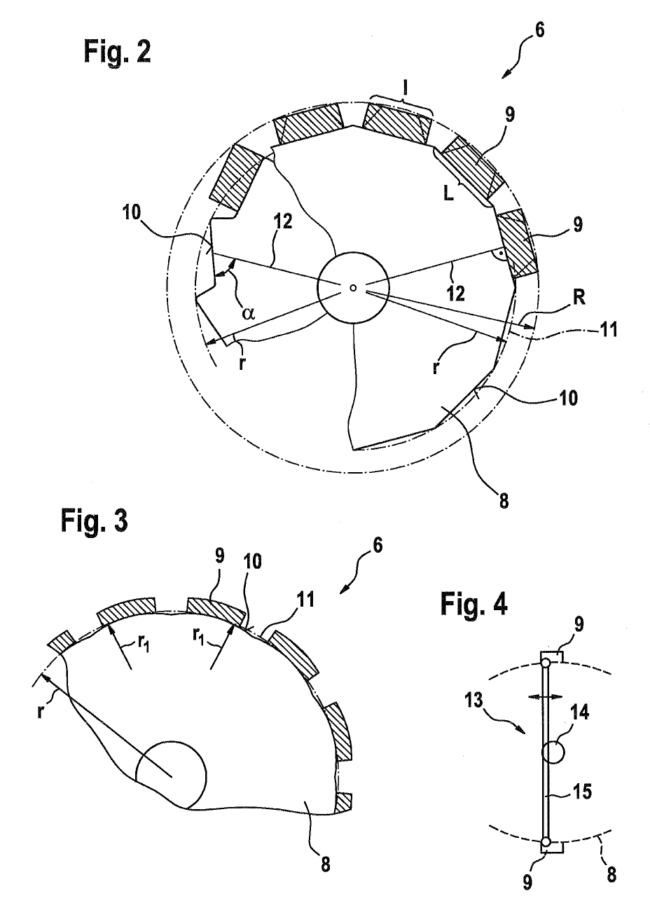

FIG. 2 is a top view of the cutting disk, which is composed of a disk body with cutting segments situated on the outer edge; the outer edge of the disk body is divided into identically embodied segment receiving sections, each of which is associated with a cutting segment,

FIG. 3 shows a detail of a cutting disk with a disk body whose outer edge has arc-shaped segment receiving sections, each for receiving a respective cutting segment,

FIG. 4 is a schematic representation of a welding device for welding the cutting segments onto the segment receiving sections on the disk body,

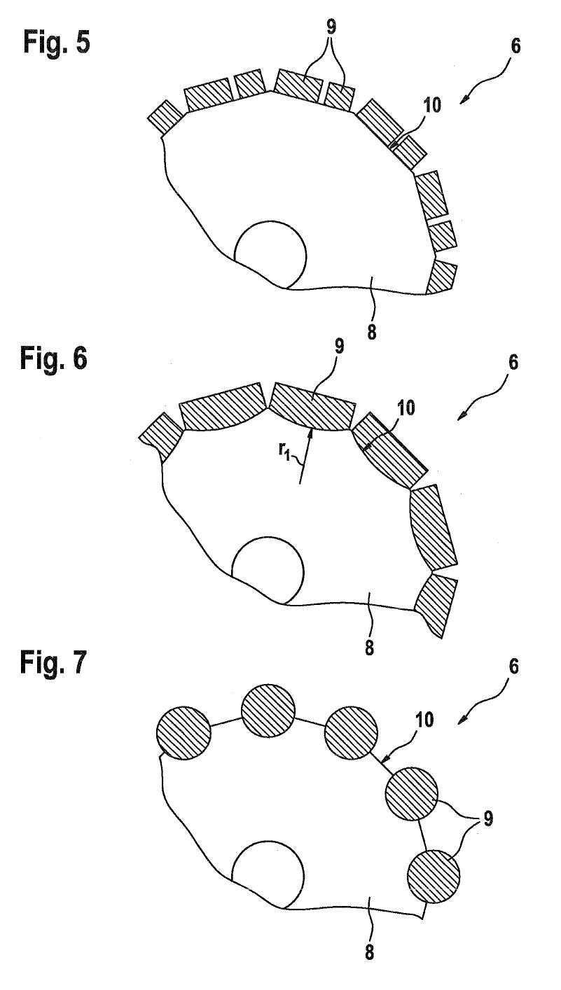

FIG. 5 shows a cutting disk with two cutting segments per segment receiving section,

FIG. 6 shows a cutting disk with concavely curved segment receiving sections,

FIG. 7 shows a cutting disk with round cutting segments.

Parts that remain the same throughout the figures have been provided with the same reference numerals.

The handheld power grinder shown in FIG. 1 is an angle grinder 1 whose housing 2 contains an electric drive motor that is supplied with current via an electric connecting cable 3. Via a transmission device, the electric drive motor drives a working spindle 4 to which a cutting disk 6 is fixed for co-rotation by means of a fastening device 5; the cutting disk 6 is partially enclosed by a safety guard 7. The cutting disk 6 is composed of a disk body 8 and cutting segments 9 that are placed onto and attached to the radial outer edge of the disk body 8.

As is clear from the top view in FIG. 2, the disk body 8 is embodied in the form of a polygon and has a plurality of identically embodied segment receiving sections 10 on the radial outer edge, each embodied for receiving a respective cutting segment 9. According to a preferred embodiment, the cutting segments 9 are embodied as rectilinear and have the length L in the circumference direction. The cutting segments 9 by contrast have a reduced length l, at least on their side oriented toward the segment receiving section 10. The cutting segments 9 are advantageously situated in the middle of each segment receiving section 10. The cutting segments 9 can be embodied as rectangular or, as shown with dot-and-dash lines in FIG. 2, trapezoidal, in which case the narrow side of the trapezoid is situated on the side oriented radially away from the segment receiving section 10.

The outer contour of the disk body 8 is enclosed by an imaginary circular envelope curve 11 that only touches the vertex points at the transition between two adjacent segment receiving sections 10. The central region of each segment receiving section 10 is recessed radially from this imaginary envelope curve 11. Concentric to the envelope curve 11 touching the segment receiving section 10 around the disk body 8, an outer envelope curve with the radius R is shown in FIG. 2, which is situated around the outline contour of the cutting segments 9.

The segment receiving sections 10 are perpendicular to a straight line 12 that passes through the center point of the disk body 8 and bisects the segment receiving sections 10. In this embodiment and with a rectilinear embodiment of the segment receiving sections 10, the disk body 8 is embodied in the form of a regular polygon.

It is also possible, however, as shown in the left half of FIG. 2, for there to be an oblique arrangement of the segment receiving section 10 so that it encloses an angle α that is not equal to 90° with the straight line 12. In this embodiment, the disk body 8 has a sawtooth-shaped circumference. In relation to the rotation direction of the disk body 8, the segment receiving sections 10 can be embodied so that they fall radially or rise radially in the circumference direction.

FIG. 3 shows another exemplary embodiment of a cutting disk 6 with a disk body and cutting segments 9 arranged along the outer edge. The individual segment receiving sections 10 on the outer edge of the disk body 8 are curved, in particular are arc-shaped and have the radius r₁, which is smaller than the radius r of the circular envelope curve 11 around the outer contour of the disk body 8. The segment receiving sections 10 are convexly shaped, with a radial curvature oriented outward; it is also essentially possible to provide them with a concave curvature oriented inward. On their side oriented toward the respective segment receiving section 9, the cutting segments 9 each have a contact surface with the same radius as the segment receiving sections. On their radially outer side, the cutting segments 9 are likewise embodied as arc-shaped.

FIG. 4 shows a welding device 13 for welding individual cutting segments 9 onto the outer contour in the vicinity of the segment receiving sections of the disk body 8. The welding device 13 is composed of a rotatable base 14 and a welding arm 15 supported thereon in movable fashion, at the opposite ends of which a respective cutting segment 9 is to be welded to the outer contour of the disk body 8. With a rectilinear embodiment of the segment receiving section, the welding process for each cutting segment 9 can be carried out solely through a translatory movement of the welding arm 15. With a curved segment receiving section, it is necessary to carry out a rotation around the axis of the foot 14 or possibly a combined motion with both rotary and translatory displacement. With a symmetrical embodiment of the welding plate 8, a cutting segment 9 can be welded onto each of the diametrically opposing sides.

In the exemplary embodiment according to FIG. 5, two cutting segments 9 are provided for each segment receiving section 10. The numbers of cutting segments 9 per segment receiving section 10 can be the same or different from one segment receiving section to the next.

In the exemplary embodiment according to FIG. 6, the individual segment receiving sections 10 are embodied as arc-shaped in a fashion similar to the exemplary embodiment according to FIG. 3 and have the radius r₁, but the segment receiving sections 10 are concavely curved so that the curvature of each segment receiving section extends radially inward.

In the exemplary embodiment according to FIG. 7, the cutting segments 9 have a round cross-sectional form. The segment receiving sections 10 are correspondingly embodied and have a contour that is adapted to the cross-sectional form of the cutting segments.

What is claimed is:

1. A cutting disk for power tools, in particular for handheld power grinders such as angle grinders (1), having a disk body (8) with at least two cutting segments (9) mounted onto its outer edge,
wherein the outer edge of the disk body (8), viewed in the circumference direction, is divided into at least two identically embodied segment receiving sections (10) that are each associated with a respective cutting segment (9); the segment receiving sections (10) are at least partially offset radially, in particular recessed from, a circular envelope curve (11) around the outer edge of the disk body (8).

2. The cutting disk as recited in claim 1,
wherein the segment receiving sections (10) are embodied as rectilinear.

3. The cutting disk as recited in claim 1,
wherein the segment receiving sections (10) are embodied as curved.

4. The cutting disk as recited in claim 3,
wherein the segment receiving sections (10) are embodied as arc-shaped and the radius (r₁) of the segment receiving sections (10) differs from, in particular is smaller than, the radius (r) of the envelope curve (11).

5. The cutting disk as recited in claim 4,
wherein the segment receiving sections (10) are convexly curved.

6. The cutting disk as recited in claim 4,
wherein the segment receiving sections (10) are concavely curved.

7. The cutting disk as recited in claim 1,
wherein at least one segment receiving section (10) is oriented so that the center line through the two circumferential end points of the segment receiving section (10) is perpendicular to a straight line (12) that passes through the center point of the disk body (8) and bisects the segment receiving section (10).

8. The cutting disk as recited in claim 1,
wherein at least one segment receiving section (10) is oriented so that the center line through the two circumferential end points of the segment receiving section (10) encloses an angle (α) not equal to 90° with a straight line (12) that passes through the center point of the disk body (8) and bisects the segment receiving section (10).

9. The cutting disk as recited in claim 7,
wherein all of the segment receiving sections (10) are oriented so that the center lines have the same angle (α) in relation to the respectively associated straight lines (12).

10. The cutting disk as recited in claim 1,
wherein all of the cutting segments (9) are identically embodied.

11. The cutting disk as recited in claim 1,
wherein adjacent cutting segments (9) face each other across a gap.

12. The cutting disk as recited in claim 1,
wherein the radial outer edge of each cutting segment (9) is embodied as rectilinear.

13. The cutting disk as recited in claim 1,
wherein the radial outer edge of each cutting segment (9) is embodied as curved, in particular arc-shaped.

14. The cutting disk as recited in claim 1,
wherein at least two cutting segments (9) are situated on at least one segment receiving section (10).

15. The cutting disk as recited in claim 1,
wherein the cutting segments (9) have a round cross-sectional shape.
